(19) United States
(12) Patent Application Publication
(10) Pub. No.: US 2014/0025381 A1
(43) Pub. Date: Jan. 23, 2014

(54) EVALUATING TEXT-TO-SPEECH INTELLIGIBILITY USING TEMPLATE CONSTRAINED GENERALIZED POSTERIOR PROBABILITY

(71) Applicants: Linfang Wang, Beijing (CN); Yan Teng, Kenmore, WA (US); Lijuan Wang, Beijing (CN); Frank Kao-Ping Soong, Beijing (CN); Zhe Geng, Beijing (CN); William Brad Waller, Seattle, WA (US); Mark Tillman Hanson, Woodinville, WA (US)

(72) Inventors: Linfang Wang, Beijing (CN); Yan Teng, Kenmore, WA (US); Lijuan Wang, Beijing (CN); Frank Kao-Ping Soong, Beijing (CN); Zhe Geng, Beijing (CN); William Brad Waller, Seattle, WA (US); Mark Tillman Hanson, Woodinville, WA (US)

(73) Assignee: MICROSOFT CORPORATION, Redmond, WA (US)

(21) Appl. No.: 13/554,480

(22) Filed: Jul. 20, 2012

(51) Int. Cl. G10L 13/08

(52) U.S. Cl. 704/260; 704/E13.011

(57) ABSTRACT

Instead of relying on humans to subjectively evaluate speech intelligibility of a subject, a system objectively evaluates the speech intelligibility. The system receives speech input and calculates confidence scores at multiple different levels using a Template Constrained Generalized Posterior Probability algorithm. One or multiple intelligibility classifiers are utilized to classify the desired entities on an intelligibility scale. A specific intelligibility classifier utilizes features such as the various confidence scores. The scale of the intelligibility classification can be adjusted to suit the application scenario. Based on the confidence score distributions and the intelligibility classification results at multiple levels an overall objective intelligibility score is calculated. The objective intelligibility scores can be used to rank different subjects or systems being assessed according to their intelligibility levels. The speech that is below a predetermined intelligibility (e.g. utterances with low confidence scores and most severe intelligibility issues) can be automatically selected for further analysis.

### BACKGROUND

Speech intelligibility is usually subjectively measured by language experts and/or native speakers. An average understanding rate or word error rate is calculated as a subjective speech intelligibility score for a particular speech coding or synthesis application. This subjective measurement can be costly, labor intensive, prone to inconsistency among subjects, and hard to scale.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Instead of relying on humans to subjectively evaluate speech intelligibility of a subject, a computing system objectively evaluates speech intelligibility. A subject to be evaluated may include: human subjects (e.g. a voice talent who is competing for a speaking role); text-to-speech (TTS) systems (e.g. car navigation . . . ); as well as other speech to be analyzed for intelligibility. Speech input is received and confidence scores are calculated at multiple different levels (e.g. phoneme, syllable, word and/or utterance level) using a Template Constrained Generalized Posterior Probability (TCGPP) algorithm. One or multiple intelligibility classifiers are utilized to classify the desired entities (e.g. phonemes, syllables, words or utterances) on an intelligibility scale. A specific intelligibility classifier utilizes features such as the various confidence scores. The scale of the intelligibility classification can be adjusted to suit the application scenario. Based on the confidence score distributions and the intelligibility classification results at multiple levels an overall objective intelligibility score is calculated. The speech that is below a predetermined intelligibility (e.g. utterances with low confidence scores and most severe intelligibility issues) can be automatically selected for further analysis.

### BRIEF DESCRIPTION OF THE DRAWINGS

FIG. 1 illustrates an exemplary objective Text-To-Speech (TTS) intelligibility assessment system;

FIG. 2 shows constructing a template for a focused phoneme;

FIG. 3 shows different templates;

FIG. 4 shows an illustrative process for objectively evaluating speech using TCGPP; and

FIGS. 5-8 and the associated descriptions provide a discussion of a variety of operating environments in which embodiments of the invention may be practiced.

### DETAILED DESCRIPTION

Referring now to the drawings, in which like numerals represent like elements, various embodiments will be described.

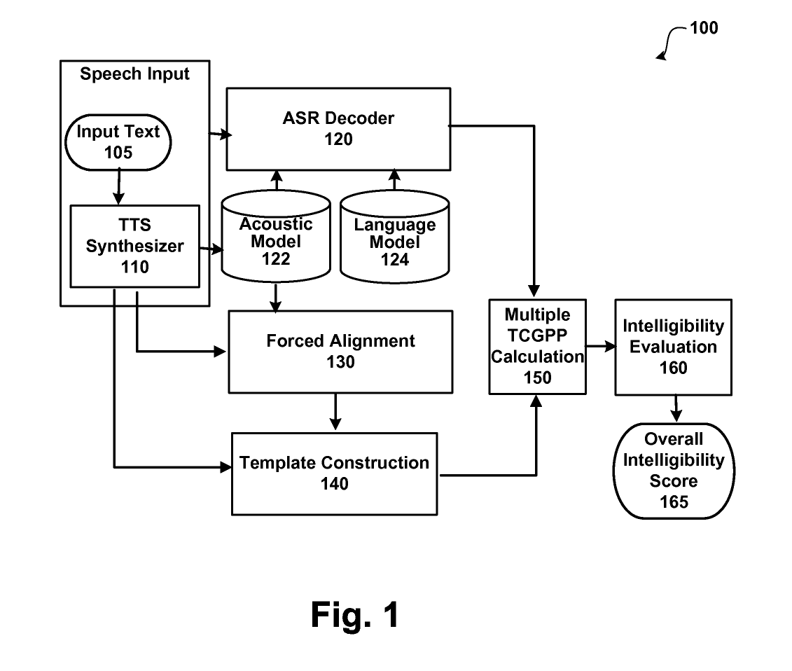

FIG. 1 illustrates an exemplary objective Text-To-Speech (TTS) intelligibility assessment system. As illustrated, system 100 includes speech input including input text 105 and TTS synthesizer 110, ASR decoder 120, acoustic model 122, language model 124, forced alignment 130, template construction 140, multiple TCGPP calculation 150, intelligibility evaluation 160 and overall intelligibility score 165.

Speech intelligibility is an overall perception of whether the speech being heard matches what the speaker is trying to convey. Speech intelligibility is a speech quality measurement for speech coding, speech synthesis and speech enhancement applications. Speech intelligibility can be affected by many factors such as whether: the speaker is a native speaker; the speaker has an accent; the speaker has clear articulation; the environment noise; the speech waves have been compressed and decompressed and/or are polluted by some particular types of noise; and the like.

Automatic Speech Recognition (ASR) decoder 120 is configured to generate a phoneme graph for the spoken input (e.g. the synthesized wave from TTS synthesizer 110) and utilizes acoustic model 122 and language model 124. According to an embodiment, language model 124 is a phoneme tri-gram model.

Acoustic model 122 is used in the Template Constrained Generalized Posterior Probability (TCGPP) calculations. Depending on the available resources, there are several ways to do speech model customization. For example, when a speaker independent speech recognition acoustic model for the tested language is available, speaker adaption techniques, such as global or regression tree based MLLR transforms, can be utilized to achieve better accuracy. When a speech recognition acoustic model is not available, a speaker dependent speech recognition acoustic model may be trained using testing utterances. Customized speech recognition language models may be built using testing utterances with existing technologies.

Forced alignment 130 determines the starting/ending time boundaries for each phoneme. The forced alignment is carried out between the initial phoneme transcription and the acoustic signals.

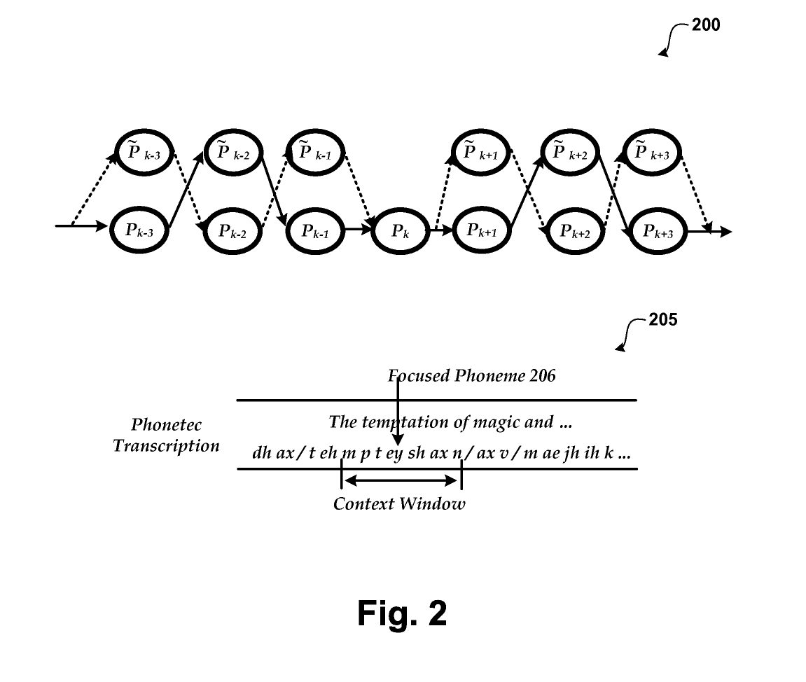

Template construction 140 constructs multiple templates. Each phoneme in the initial phoneme transcription is a focused phoneme. Rather than constructing one template with optimized parameters, multiple templates are constructed according to the focused phoneme and its left and right context phonemes. By setting a context window length (see FIG. 2), the threshold for selecting the number of confusable phonemes, and the partial matching ratio, multiple templates are generated. Some more rigid templates are constructed according to the specific context, while other templates are more flexibly constructed with more confusable phonemes or a lower partial match ratio. Multiple templates of different hypothesis sifting capabilities are used (from well-defined, full context to loosely defined context like wild card to measure corresponding confidence at different expected accuracy). The TCGPP values for each of the templates of each phoneme are calculated.

In written format, a string hypothesis used to represent utterances. A string hypothesis is an ordered sequence of pronunciation entities (e.g., phonemes, syllables or words). For a specific phoneme, syllable or word, the problem becomes: given a sequence of acoustic observations, among all its possible string hypothesis, what is the posterior possibility of the expected string hypothesis (correct pronunciation).

A template constrained generalized posterior probability (TCGPP) algorithm is used to calculate local (phoneme, syllable, word level) confidence scores. Multiple templates are generated using different criteria. Thus, for each individual phoneme, syllable or word, multiple confidence scores can be obtained. Intelligibility evaluation 160 uses phoneme, syllable, word level intelligibility classifier(s) to classify each phoneme, syllable or word as intelligible or unintelligible, or, depending on the requirement, as totally intelligible, mostly intelligible, equally intelligible and unintelligible, mostly unintelligible, or totally unintelligible.

An overall speech intelligibility score 165 is then calculated mainly based on the distributions of the various local intelligibility confidence scores, and the amount of local intelligibility issues.

Multiple templates are constructed by template construction 140. Generally, a Template is denoted by a triple [T; r; s, t]. A Template T is a pattern composed of hypothesized units and metacharacters that can support regular expression syntax. r stands for the partial match ratio and ranges between 0 and 100%. In other words, the relevant path does not need to match the entire template. [s, t] defines the time frame constraint on the template.

Once a template is constructed by template construction 140, an appropriate hypothesis set H([T; r; s, t]) is determined by matching each of the string hypothesis against the template. The hypothesis set under stringent template constraints can be much smaller than that under the traditional GPP approaches. The Template Constrained Posterior (TCGPP) of [T; r; s, t] is calculated as the generalized posterior probability summed on all the string hypotheses in H([T; r; s, t]), as EQUATION shows.

$$P ( [ T ; r ; s , t ] \vert {x}_{1}^{T} ) = {\sum }_{{N , h = {[ w , s , t ]}_{1}^{N}}_{h ∈ H ( [ T ; r ; s , t ] )}} \frac{{\prod }_{n = 1}^{N} {P}^{a} ( {x}_{{s}_{n}}^{{t}_{n}} \vert {w}_{n} ) \cdot {P}^{β} ( {w}_{n} \vert {w}_{1}^{n} )}{p ( {x}_{1}^{T} )} \qquad EQUATION 1$$

where x₁^{T} is the whole sequence of acoustic observations, α and β are the exponential weights for the acoustic and language model likelihoods, respectively. In calculating TCGPP, the reduced search space, the time relaxation registration, and the weighted acoustic and language model likelihood are handled similarly as generalized posterior probability (GPP). A difference between the TCGPP and GPP is the determination of the string hypotheses set, which corresponds to the term under the sigma summation notation.

The TCGPP approach examines both the focused unit and the context to the left and right of the focused unit. In this way, the TCGPP approach provides additional robustness against incorrect time boundaries, which may be caused by insertion, deletion, or substitution errors. Also, the proposed template constrained approach uses templates to limit the hypothesis set during the posterior probability calculation for a selected focus unit. These templates may be customized to accommodate different level of granularity, a useful option in measuring confidence at different precision.

In the current example of system 100, TCGPP is being used to evaluate the synthesized speech against the text fed into TTS synthesizer 110. The flexibility of TCGPP allows TCGPP to examine the synthesized speech at a fine granularity level, given the input text transcription as reference. To achieve the fine granularity level, multiple templates are constructed with loose to restrict configurations and multiple confidence scores can be obtained for each individual phoneme. Moreover, an overall speech intelligibility score can be further calculated based on local intelligibility confidence scores to compare and rank multiple TTS systems.

In experimental results, system 100 has evaluated different TTS voices. As a reference, word error rate (WER) by human dictation on a test set is taken as the ground truth of the voice intelligibility. Meanwhile, the accuracy of ASR, word recognition rate (WRR), is employed as the baseline of the objective intelligibility assessed by computer. The proposed objective intelligibility measure can be compared with both human (upper bound) and ASR (lower bound) results.

In one test, three voice fonts are built by three different TTS systems using 6000 utterances read by a female US native speaker. These three TTS voices are built with different backend synthesis technologies: two (voice1 and voice2) are unit selection based; and the third one (voice3) is HMM based synthesis. A test set of 330 sentences is generated by the three TTS systems respectively. Their speech intelligibility is evaluated by human language experts by examining the mispronounced word after listening to the synthesized speech without time constraints. Also, automatic speech recognition is conducted on the same test set to get the WRRs as the baseline for objective intelligibility assessment.

Note that the word error rate (WER) by human listening test is converted to subjective understanding rate (SUR) to make them congruent with intelligibility score we calculated: SUR=100−WER

Table 1 (below) shows the SUR (by human), the WRR (by ASR), and the proposed objective overall intelligibility scores (linearly normalized to [0, 100]). In this task, both the ASR and the proposed measure can correlate with human perception well.

TABLE 1
Subjective and objective intelligibility score of the three TTS
voice fonts. TTS voice

| | SUR | WRR | Objective |
|---|---|---|---|
| | (by | (by | Intelligibility |
| | human) | ASR) | Score |
| 1 | 98.4 | 58.2 | 59.3 |
| 2 | 99.1 | 68.5 | 61.8 |
| 3 | 99.5 | 73.0 | 67.6 |

FIG. 2 shows constructing a template for a focused phoneme.

Phoneme level TCGPP is used as a confidence measure to identify potential phoneme errors in synthesized speech sentences. In the current example, a template [T; r; s, t] 200 is being constructed for focused phoneme (206) pₖ. p_{k-L} . . . pₖ . . . p_{k+L} is the phoneme string 205 covering the 2L context phonemes before and after Pₖ.

Pₖ is the phoneme string covering the 2L context phonemes before and after pₖ. \tilde{p}ₖ represents the confusable phoneme of pᵢ (k−L≦i≦k+L). The confusability between two phonemes is assessed by the Kullback-Leibler Divergence (KLD), which is a measure of the dissimilarity between two probabilistic models (distributions). r is the partial match ratio among the 2L context phonemes. [s, t] defines the time frame constraint of the template, i.e., s is the start time of p_{k-L} and t is the end time of p_{k+L}. The hypotheses set H for [T; r; s, t], as defined in EQUATION 1 (above), is obtained by finding each string hypothesis that contains a subpath that r % partially matches the template and also overlaps the specified time interval [s, t].

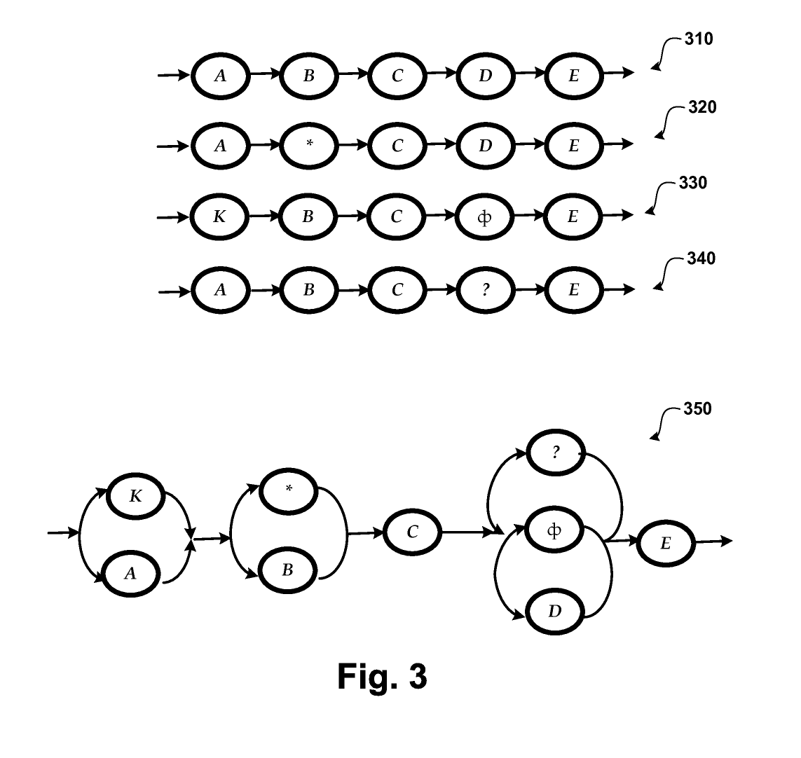

FIG. 3 shows different templates.

Template 310 shows a basic template that depicts a simplest type of template, ABCDE, where C is the focus unit, and AB and DE are the left and right context, respectively.

Template 320 shows a template with a wildcard denoted by “*.” Template 320 follows the pattern A*CDE where the wild-card * indicates an arbitrary character in that particular position. For example, A*CDE matches any of: AACDE, AFCDE, or ACDE.

Template 330 follows the pattern ABCφE that includes a blank “φ” that indicates a null in this position.

Template 340 follows the pattern ABC?E that includes a question mark “?” that indicates that the word which appears in this position has not been identified yet.

The basic templates (310, 320, 330 and 340) may be combined to construct a compound template, such as template 350. Many other compound templates may be constructed. With reference to compound template 350 illustrated in FIG. 3, a matching string hypothesis may include either A or K in the 1st position, include B or any element at the 2nd position, includes C at the center position, and so on. Depending upon the specified minimal matching constraint and whether some or all of these elements can be partially matched, the search space generated from compound template 350 may be substantially larger than that generated from a basic template.

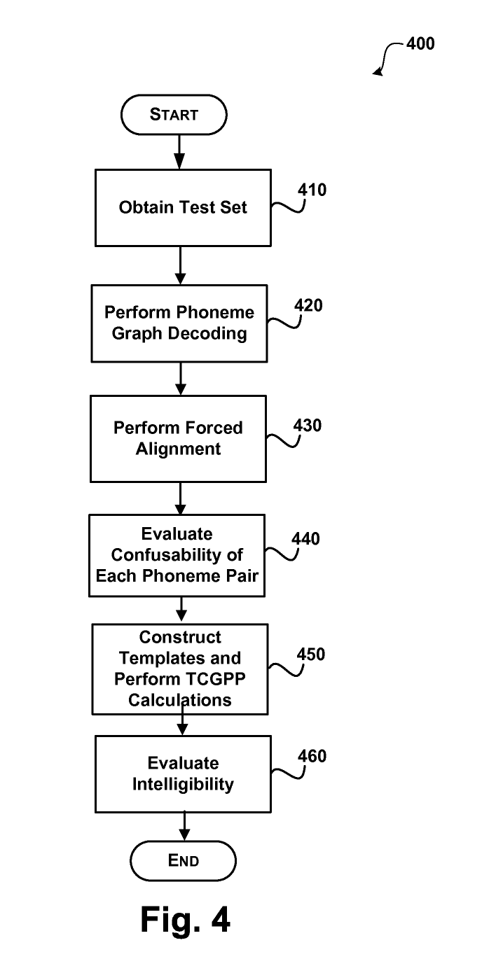

FIG. 4 shows an illustrative process for objectively evaluating speech using TCGPP. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof.

After a start operation, process 400 flows to operation 410, where the test set is obtained. For example, a text script may be read by TTS synthesizer and/or a human subject. The phoneme transcription of the test set is also obtained. The phoneme transcription may be generated by a standard frontend and then refined by human experts to assist in avoiding frontend errors. The output of the test set is a synthesized waveform.

Moving to operation 420, phoneme graph decoding is performed. Generally, phoneme graph decoding generates a phoneme graph for the output of the test set using an acoustic model and language model.

Flowing to operation 430, forced alignment is performed. To determine the starting/ending time boundaries for each phoneme, forced alignment is carried out between the initial phoneme transcription and the acoustic signals.

Transitioning to operation 440, an evaluation of confusability of each phoneme pair is performed. According to an embodiment, the confusability of each phoneme pair is assessed by the Kullback-Leibler Divergence (KLD) calculated upon the acoustic model.

Moving to operation 450, templates are constructed and TCGPP calculation is performed. Each phoneme in the initial phoneme transcription is regarded as a focused phoneme. For example the focused phoneme “ey” as illustrated in FIG. 2. Rather than construct one template with optimized parameters, multiple templates are constructed according to the focused phoneme and its left and right context phonemes. By setting the context window length (see FIG. 2), the threshold for selecting the number of confusable phonemes, and the partial matching ratio, multiple templates are generated. Some more rigid templates may be constructed according to the specific context, while others are more flexibly constructed with more confusable phonemes or lower partial match ratio. Multiple templates of different hypothesis sifting capabilities are used (from well-defined, full context to loosely defined context like wild card) to measure corresponding confidence at different expected accuracy. The TCGPP values for each of the templates of each phoneme are calculated.

Flowing to operation 460, the intelligibility is objectively evaluated. For each focused phoneme in the input phonetic transcription, multiple TCGPP values are calculated to evaluate the focused phoneme using different precisions. The syllable and/or word level confidence score is calculated by averaging or taking the minimum of the confidence scores of the phonemes it contains. The scores for phoneme, syllable, and word are all posterior probabilities, ranging from 0 to 1. According to an embodiment, posterior scores are summarized into a single metric to represent the intelligibility of the measured TTS system. The overall objective intelligibility score (OIS) can generally be calculated as follows:

$$O I S = {\sum }_{k = 1}^{K} {w}_{k} ( \frac{1}{{M}_{k}} {\sum }_{m = 1}^{{M}_{k}} {P}_{k , m} )$$

where k=1, . . . , K represents different granularity levels (i.e., phoneme, syllable, word, utterance, etc.) considered; wₖ is the weight for the k^{th} level; Mₖ represents the number of focused units at the k^{th} granularity level; P_{k,m} is the average of the multiple TCGPP confidence scores for the focused unit. The raw objective speech intelligibility can be linearly transformed to any specific range (e.g. [0,100]) and the like.

If multiple granularity level intelligibility classification is utilized,

$$O I S = {\sum }_{k = 1}^{K} {w}_{k} ( {α}_{k} {\sum }_{m = 1}^{{M}_{k}} \frac{1}{{M}_{k}} {P}_{k , m} + {β}_{k} {R}_{k} )$$

where k=1, . . . , K represents different granularity levels (i.e., phoneme, syllable, word, utterance, etc.) considered; wₖ is the weight for the k^{th} level; Mₖ represents the number of focused units at the k^{th} granularity level; P_{k,m} is the average of the multiple TCGPP confidence scores for the focused unit; Rₖ is the ratio of unintelligible focused units at the k^{th} granularity level; αₖ is the weight for the average intelligibility confidence scores at the k^{th} granularity level; βₖ is the weight of the unintelligible ratio at the k^{th} granularity level. The raw objective speech intelligibility can be linearly transformed to any specific range (e.g. [0,100]) and the like.

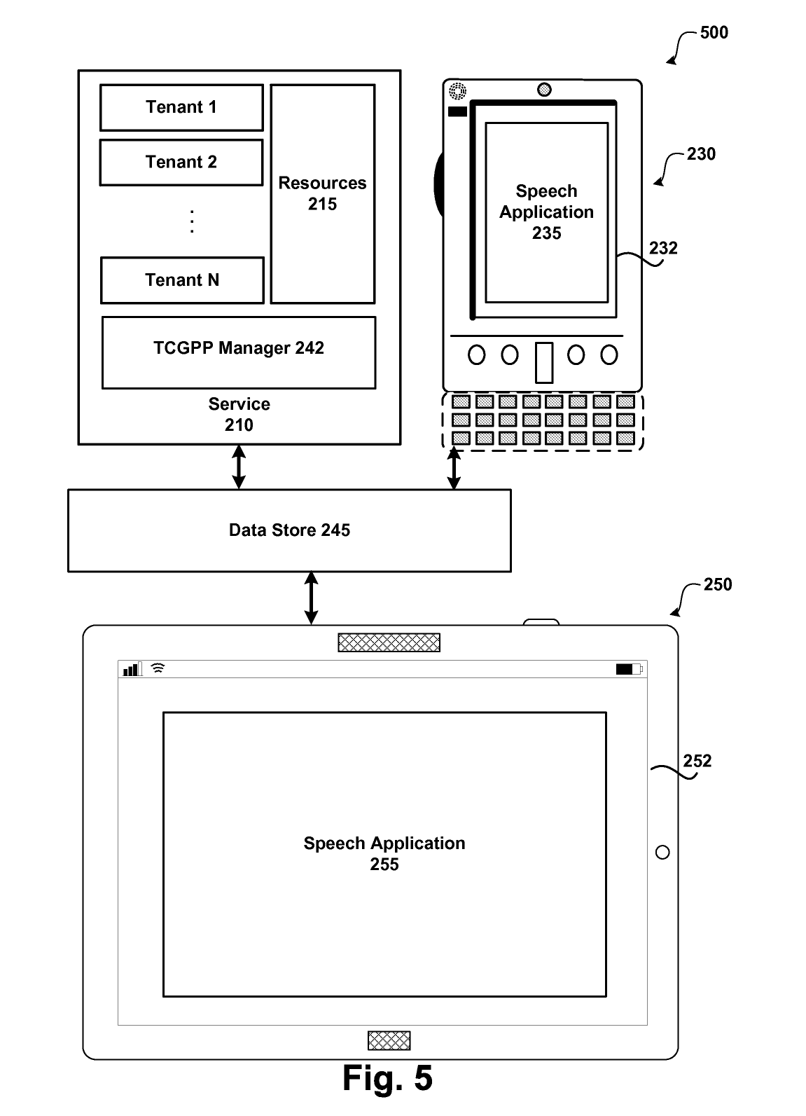

FIG. 5 illustrates an exemplary system objectively evaluating speech using TCGPP. As illustrated, system 500 includes service 210, data store 245, touch screen input device/display 250 (e.g. a slate) and smart phone 230.

As illustrated, service 210 is a cloud based and/or enterprise based service that may be configured to provide services, such as productivity services (e.g. MICROSOFT OFFICE 365 or some other cloud based/online service that is used to interact with items (e.g. messages, spreadsheets, documents, charts, and the like). The service may be interacted with using different types of input/output. For example, a user may use touch input, hardware based input, speech input, and the like. Functionality of one or more of the services/applications provided by service 210 may also be configured as a client/server based application. For example, a client device may include an application that performs operations that utilize speech objectively evaluated using TCGPP. Although system 500 shows a service relating to productivity applications, other services/applications may be configured.

As illustrated, service 210 is a multi-tenant service that provides resources 215 and services to any number of tenants (e.g. Tenants 1-N). Multi-tenant service 210 is a cloud based service that provides resources/services 215 to tenants subscribed to the service and maintains each tenant's data separately and protected from other tenant data.

System 500 as illustrated comprises a touch screen input device/display 250 (e.g. a slate/tablet device) and smart phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

According to an embodiment, smart phone 230 and touch screen input device/display 250 are configured to receive text/speech input and output text/speech. Smart phone 230 and touch screen input device/display 250 may also be configured to include speech applications (e.g. applications 235 and 255) related to one or more of: automatic speech recognition, Natural Language Processing (NLP), text-to-speech, and the like.

As illustrated, touch screen input device/display 250 and smart phone 230 shows exemplary displays 252/232 showing the use of an application using speech (235, 255). For example, a user associated with slate device 250 may be using application 255 to find a restaurant. A user associated with smartphone 230 may be interacting with application 235 that provides navigation services. Many other types of applications may utilize speech. Data may be stored on a device (e.g. smart phone 230, slate 250 and/or at some other location (e.g. network data store 245). The applications 235, 255 may be a client based application, a server based application, a cloud based application and/or some combination.

TCGPP manager 242 is configured to perform operations relating to speech applications (e.g. automatic speech recognition, Natural Language Processing (NLP), text-to-speech, and the like). While manager 242 is shown within service 210, the functionality of the manager may be included in other locations (e.g. on smart phone 230 and/or slate device 250).

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

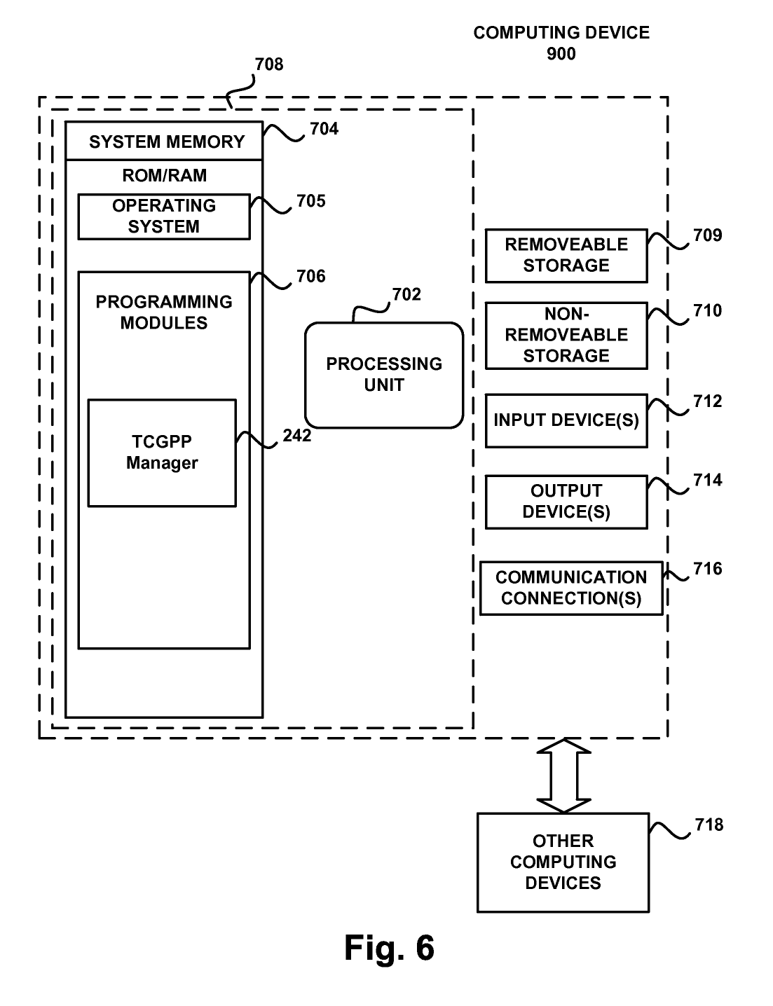

FIGS. 6-8 and the associated descriptions provide a discussion of a variety of operating environments in which embodiments of the invention may be practiced. However, the devices and systems illustrated and discussed with respect to FIGS. 6-8 are for purposes of example and illustration and are not limiting of a vast number of computing device configurations that may be utilized for practicing embodiments of the invention, described herein.

FIG. 6 is a block diagram illustrating example physical components of a computing device 900 with which embodiments of the invention may be practiced. The computing device components described below may be suitable for the computing devices described above. In a basic configuration, computing device 900 may include at least one processing unit 702 and a system memory 704. Depending on the configuration and type of computing device, system memory 704 may comprise, but is not limited to, volatile (e.g. random access memory (RAM)), non-volatile (e.g. read-only memory (ROM)), flash memory, or any combination. System memory 704 may include operating system 705, one or more programming modules 706, and may include a web browser application 720. Operating system 705, for example, may be suitable for controlling computing device 900's operation. In one embodiment, programming modules 706 may include a TCGPP manager 242, as described above, installed on computing device 900. Furthermore, embodiments of the invention may be practiced in conjunction with a graphics library, other operating systems, or any other application program and is not limited to any particular application or system. This basic configuration is illustrated in FIG. 6 by those components within a dashed line 708.

Computing device 900 may have additional features or functionality. For example, computing device 900 may also include additional data storage devices (removable and/or non-removable) such as, for example, magnetic disks, optical disks, or tape. Such additional storage is illustrated in FIG. 6 by a removable storage 709 and a non-removable storage 710.

As stated above, a number of program modules and data files may be stored in system memory 704, including operating system 705. While executing on processing unit 702, programming modules 706, such as the manager may perform processes including, for example, method 400 as described above. The aforementioned process is an example, and processing unit 702 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. For example, embodiments of the invention may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the manager 242 may be operated via application-specific logic integrated with other components of the computing device/system 900 on the single integrated circuit (chip). Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process.

The term computer readable media as used herein may include computer storage media. Computer storage media may include volatile and nonvolatile, removable and non-removable media implemented in any method or technology for storage of information, such as computer readable instructions, data structures, program modules, or other data. System memory 704, removable storage 709, and non-removable storage 710 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 900. Any such computer storage media may be part of device 900. Computing device 900 may also have input device(s) 712 such as a keyboard, a mouse, a pen, a sound input device, a touch input device, etc. Output device(s) 714 such as a display, speakers, a printer, etc. may also be included. The aforementioned devices are examples and others may be used.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

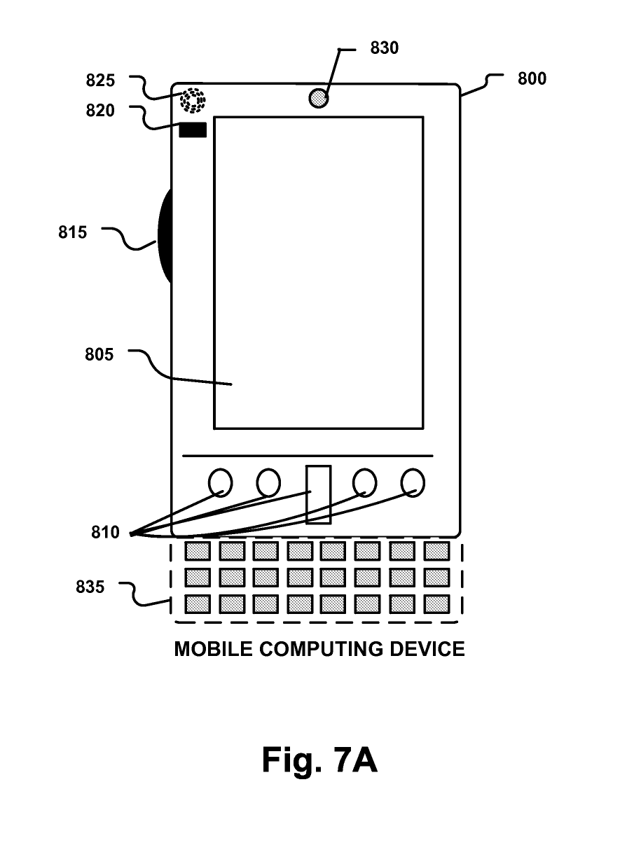

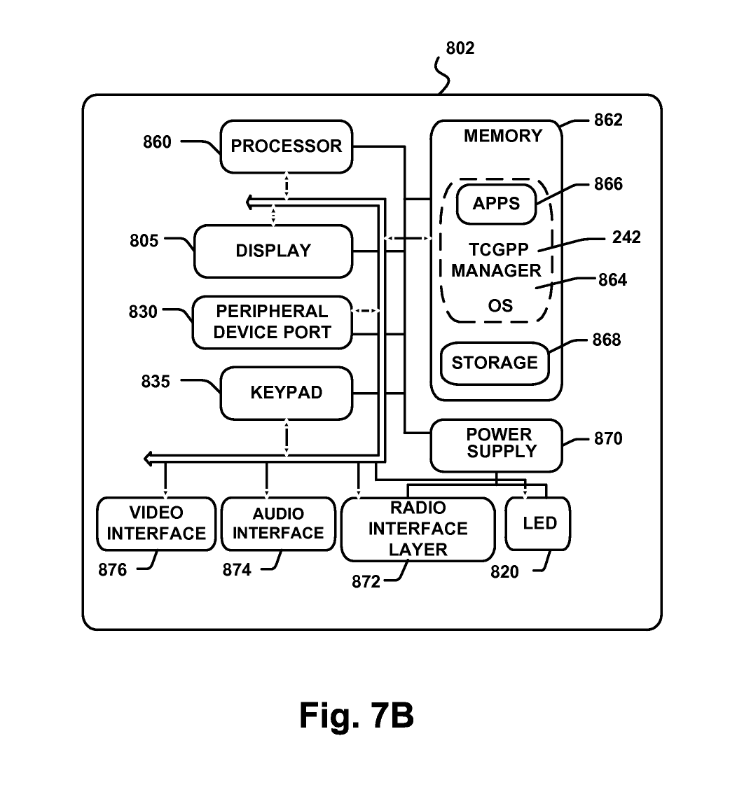

FIGS. 7A and 7B illustrate a suitable mobile computing environment, for example, a mobile telephone, a smartphone, a tablet personal computer, a laptop computer, and the like, with which embodiments of the invention may be practiced. With reference to FIG. 7A, an example mobile computing device 800 for implementing the embodiments is illustrated. In a basic configuration, mobile computing device 800 is a handheld computer having both input elements and output elements. Input elements may include touch screen display 805 and input buttons 815 that allow the user to enter information into mobile computing device 800. Mobile computing device 800 may also incorporate an optional side input element 815 allowing further user input. Optional side input element 815 may be a rotary switch, a button, or any other type of manual input element. In alternative embodiments, mobile computing device 800 may incorporate more or less input elements. For example, display 805 may not be a touch screen in some embodiments. In yet another alternative embodiment, the mobile computing device is a portable phone system, such as a cellular phone having display 805 and input buttons 815. Mobile computing device 800 may also include an optional keypad 835. Optional keypad 815 may be a physical keypad or a “soft” keypad generated on the touch screen display.

Mobile computing device 800 incorporates output elements, such as display 805, which can display a graphical user interface (GUI). Other output elements include speaker 825 and LED light 820. Additionally, mobile computing device 800 may incorporate a vibration module (not shown), which causes mobile computing device 800 to vibrate to notify the user of an event. In yet another embodiment, mobile computing device 800 may incorporate a headphone jack (not shown) for providing another means of providing output signals.

Although described herein in combination with mobile computing device 800, in alternative embodiments the invention is used in combination with any number of computer systems, such as in desktop environments, laptop or notebook computer systems, multiprocessor systems, micro-processor based or programmable consumer electronics, network PCs, mini computers, main frame computers and the like. Embodiments of the invention may also be practiced in distributed computing environments where tasks are performed by remote processing devices that are linked through a communications network in a distributed computing environment; programs may be located in both local and remote memory storage devices. To summarize, any computer system having a plurality of environment sensors, a plurality of output elements to provide notifications to a user and a plurality of notification event types may incorporate embodiments of the present invention.

FIG. 7B is a block diagram illustrating components of a mobile computing device used in one embodiment, such as the computing device shown in FIG. 7A. That is, mobile computing device 800 can incorporate system 802 to implement some embodiments. For example, system 802 can be used in implementing a “smart phone” that can run one or more applications similar to those of a desktop or notebook computer such as, for example, browser, e-mail, scheduling, instant messaging, and media player applications. In some embodiments, system 802 is integrated as a computing device, such as an integrated personal digital assistant (PDA) and wireless phoneme.

One or more application programs 866 may be loaded into memory 862 and run on or in association with operating system 864. Examples of application programs include phoneme dialer programs, e-mail programs, PIM (personal information management) programs, word processing programs, spreadsheet programs, Internet browser programs, messaging programs, and so forth. System 802 also includes non-volatile storage 868 within memory 862. Non-volatile storage 868 may be used to store persistent information that should not be lost if system 802 is powered down. Applications 866 may use and store information in non-volatile storage 868, such as e-mail or other messages used by an e-mail application, and the like. A synchronization application (not shown) may also reside on system 802 and is programmed to interact with a corresponding synchronization application resident on a host computer to keep the information stored in non-volatile storage 868 synchronized with corresponding information stored at the host computer. As should be appreciated, other applications may be loaded into memory 862 and run on the device 800, including the TCGPP manager 242, described above.

System 802 has a power supply 870, which may be implemented as one or more batteries. Power supply 870 might further include an external power source, such as an AC adapter or a powered docking cradle that supplements or recharges the batteries.

System 802 may also include a radio 872 that performs the function of transmitting and receiving radio frequency communications. Radio 872 facilitates wireless connectivity between system 802 and the “outside world”, via a communications carrier or service provider. Transmissions to and from radio 872 are conducted under control of OS 864. In other words, communications received by radio 872 may be disseminated to application programs 866 via OS 864, and vice versa.

Radio 872 allows system 802 to communicate with other computing devices, such as over a network. Radio 872 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

This embodiment of system 802 is shown with two types of notification output devices; LED 820 that can be used to provide visual notifications and an audio interface 874 that can be used with speaker 825 to provide audio notifications. These devices may be directly coupled to power supply 870 so that when activated, they remain on for a duration dictated by the notification mechanism even though processor 860 and other components might shut down for conserving battery power. LED 820 may be programmed to remain on indefinitely until the user takes action to indicate the powered-on status of the device. Audio interface 874 is used to provide audible signals to and receive audible signals from the user. For example, in addition to being coupled to speaker 825, audio interface 874 may also be coupled to a microphone 820 to receive audible input, such as to facilitate a telephone conversation. In accordance with embodiments of the present invention, the microphone 820 may also serve as an audio sensor to facilitate control of notifications, as will be described below. System 802 may further include video interface 876 that enables an operation of on-board camera 830 to record still images, video stream, and the like.

A mobile computing device implementing system 802 may have additional features or functionality. For example, the device may also include additional data storage devices (removable and/or non-removable) such as, magnetic disks, optical disks, or tape. Such additional storage is illustrated in FIG. 6B by storage 868. Computer storage media may include volatile and nonvolatile, removable and non-removable media implemented in any method or technology for storage of information, such as computer readable instructions, data structures, program modules, or other data.

Data/information generated or captured by the device 800 and stored via the system 802 may be stored locally on the device 800, as described above, or the data may be stored on any number of storage media that may be accessed by the device via the radio 872 or via a wired connection between the device 800 and a separate computing device associated with the device 800, for example, a server computer in a distributed computing network such as the Internet. As should be appreciated such data/information may be accessed via the device 800 via the radio 872 or via a distributed computing network. Similarly, such data/information may be readily transferred between computing devices for storage and use according to well-known data/information transfer and storage means, including electronic mail and collaborative data/information sharing systems.

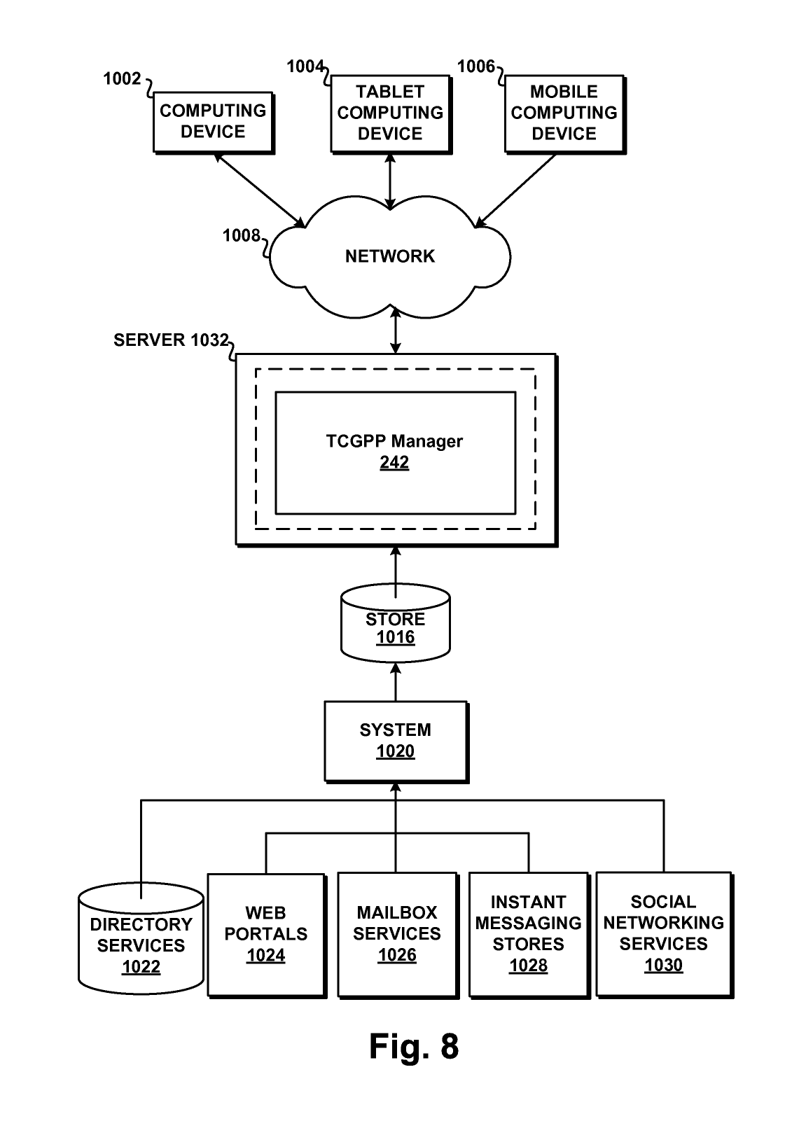

FIG. 8 illustrates a system architecture for using TCGPP, as described above.

Components managed via the TCGPP manager 242 may be stored in different communication channels or other storage types. For example, components along with information from which they are developed may be stored using directory services 1022, web portals 1024, mailbox services 1026, instant messaging stores 1028 and social networking sites 1030. The systems/applications 242, 1020 may use any of these types of systems or the like for enabling management and storage of components in a store 1016. A server 1032 may provide communications for managed components and content to clients. As one example, server 1032 may provide speech related services. Server 1032 may provide services and content over the web to clients through a network 1008. Examples of clients that may utilize server 1032 include computing device 1002, which may include any general purpose personal computer, a tablet computing device 1004 and/or mobile computing device 1006 which may include smart phones. Any of these devices may obtain display component management communications and content from the store 1016.

Embodiments of the present invention are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for objective speech intelligibility evaluation of Text-To-Speech (TTS) (but not limited to TTS) using Template Constrained Generalized Posterior Probability (TCGPP), comprising:
performing phoneme graph decoding on speech input to determine phonemes;
performing alignment to determine a starting time boundary and an ending time boundary for each of the phonemes;
evaluating confusability of phoneme pairs;
constructing templates;
performing TCGPP calculations on each of the templates; and
objectively evaluating intelligibility for the speech input.

2. The method of claim 1, further comprising obtaining the speech input from a text to speech (TTS) synthesizer.

3. The method of claim 1, wherein constructing the templates comprises constructing the templates according to each focused phoneme and a left context phoneme and a right context phoneme for the focused phoneme.

4. The method of claim 1, wherein objectively evaluating intelligibility for the speech input comprises using the TCGPP calculations to evaluate focused phonemes for focused phonemes at different precisions.

5. The method of claim 1, wherein objectively evaluating intelligibility for the speech input comprises calculating an overall objective intelligibility score (OIS) according to
$$O I S = {\sum }_{k = 1}^{K} {w}_{k} ( \frac{1}{{M}_{k}} {\sum }_{m = 1}^{{M}_{k}} {P}_{k , m} )$$
where k=1, . . . , K represents different granularity levels considered; wₖ is the weight for the k^{th} level; Mₖ represents a number of focused units at the k^{th} granularity level; P_{k,m} is an average of the multiple TCGPP confidence scores for a focused unit.

6. The method of claim 1, further comprising determining a hypothesis set H(T; r; s, t]) for each for each of the templates where T is a pattern composed of hypothesized units and metacharacters that can support regular expression syntax; r stands for a partial match ratio and [s, t] defines a time frame constraint on the template.

7. The method of claim 6, wherein a TCGPP of [T; r; s, t] is calculated as a generalized posterior probability summed on string hypothesis in H(T; r; s, t]) as:
$$P ( [ T ; r ; s , t ] \vert {x}_{1}^{T} ) = {\sum }_{{N , , h = {[ w , s , t ]}_{1}^{N}}_{h ∈ H ( [ T ; r ; s , t ] )}} \frac{{\prod }_{n = 1}^{N} {P}^{a} ( {x}_{{s}_{n}}^{{t}_{n}} \vert {w}_{n} ) \cdot {P}^{β} ( {w}_{n} \vert {w}_{1}^{n} )}{p ( {x}_{1}^{T} )}$$
where x₁^{T} is the whole sequence of acoustic observations, α and β are exponential weights for an acoustic model likelihood and a language model likelihoods.

8. The method of claim 7, wherein obtaining a hypothesis set comprises finding each string hypothesis that contains a subpath that r % partially matches the template and also overlaps the specified time interval [s, t].

9. The method of claim 1, further comprising obtaining a test set comprising an output from a TTS synthesizer of a text script and obtaining a phoneme transcription of the test set.

10. The method of claim 1, further comprising calculating confidence scores at different levels.

11. A computer-readable medium having computer-executable instructions for evaluation of Text-To-Speech (TTS) using Template Constrained Generalized Posterior Probability (TCGPP), comprising:
performing phoneme graph decoding on synthesized speech input to determine phonemes;
performing alignment to determine a starting time boundary and an ending time boundary for each of the phonemes;
constructing templates;
performing TCGPP calculations on each of the templates; and
objectively evaluating intelligibility for the speech input.

12. The computer-readable medium of claim 11, wherein constructing the templates comprises constructing the templates according to each focused phoneme.

13. The computer-readable medium of claim 11, wherein objectively evaluating intelligibility for the speech input comprises using the TCGPP calculations to evaluate focused phonemes for focused phonemes at different precisions.

14. The computer-readable medium of claim 11, wherein objectively evaluating intelligibility for the speech input comprises calculating an overall objective intelligibility score (OIS) according to
$$O I S = {\sum }_{k = 1}^{K} {w}_{k} ( \frac{1}{{M}_{k}} {\sum }_{m = 1}^{{M}_{k}} {P}_{k , m} )$$
where k=1, . . . , K represents different granularity levels considered; wₖ is the weight for the k^{th} level; Mₖ represents a number of focused units at the k^{th} granularity level; P_{k,m} is an average of the multiple TCGPP confidence scores for a focused unit.

15. The computer-readable medium of claim 11, further comprising determining a hypothesis set H(T; r; s, t]) for each for each of the templates where T is a pattern composed of hypothesized units and metacharacters that can support regular expression syntax; r stands for a partial match ratio and [s, t] defines a time frame constraint on the template.

16. The computer-readable medium of claim 15, wherein a TCGPP of [T; r; s, t] is calculated as a generalized posterior probability summed on string hypothesis in H(T; r; s, t]) as:
$$P ( [ T ; r ; s , t ] \vert {x}_{1}^{T} ) = {\sum }_{{N , , h = {[ w , s , t ]}_{1}^{N}}_{h ∈ H ( [ T ; r ; s , t ] )}} \frac{{\prod }_{n = 1}^{N} {P}^{a} ( {x}_{{s}_{n}}^{{t}_{n}} \vert {w}_{n} ) \cdot {P}^{β} ( {w}_{n} \vert {w}_{1}^{n} )}{p ( {x}_{1}^{T} )}$$
where x₁^{T} is the whole sequence of acoustic observations, α and β are exponential weights for an acoustic model likelihood and a language model likelihoods.

17. The computer-readable medium of claim 16, wherein obtaining a hypothesis set comprises finding each string hypothesis that contains a subpath that r % partially matches the template and also overlaps the specified time interval [s, t].

18. A system for evaluation of Text-To-Speech (TTS) using Template Constrained Generalized Posterior Probability (TCGPP), comprising:
a processor and a computer-readable medium;
an operating environment stored on the computer-readable medium and executing on the processor; and
a manager operating under the control of the operating environment and operative to actions comprising:
performing phoneme graph decoding on synthesized speech input to determine phonemes;
performing alignment to determine a starting time boundary and an ending time boundary for each of the phonemes;
constructing templates according to each focused phoneme and a left phoneme and a right phoneme for the focused phoneme;
performing TCGPP calculations on each of the templates; and
objectively evaluating intelligibility for the speech input.

19. The system of claim 18, wherein objectively evaluating intelligibility for the speech input comprises calculating an overall objective intelligibility score (OIS) according to
$$O I S = {\sum }_{k = 1}^{K} {w}_{k} ( \frac{1}{{M}_{k}} {\sum }_{m = 1}^{{M}_{k}} {P}_{k , m} )$$
where k=1, . . . , K represents different granularity levels considered; wₖ is the weight for the k^{th} level; Mₖ represents a number of focused units at the k^{th} granularity level; P_{k,m} is an average of the multiple TCGPP confidence scores for a focused unit.

20. The system of claim 18, wherein a TCGPP of [T; r; s, t] is calculated as a generalized posterior probability summed on string hypothesis in H(T; r; s, t]) as:
$$P ( [ T ; r ; s , t ] \vert {x}_{1}^{T} ) = {\sum }_{{N , , h = {[ w , s , t ]}_{1}^{N}}_{h ∈ H ( [ T ; r ; s , t ] )}} \frac{{\prod }_{n = 1}^{N} {P}^{a} ( {x}_{{s}_{n}}^{{t}_{n}} \vert {w}_{n} ) \cdot {P}^{β} ( {w}_{n} \vert {w}_{1}^{n} )}{p ( {x}_{1}^{T} )}$$
where x₁^{T} is the whole sequence of acoustic observations, α and β are exponential weights for an acoustic model likelihood and a language model likelihoods.
